(19) United States
(12) Patent Application Publication
(10) Pub. No.: US 2008/0068778 A1
(43) Pub. Date: Mar. 20, 2008

(54) MULTI-LAYER CERAMIC CAPACITOR AND MANUFACTURING METHOD THEREOF

(76) Inventors: Katsuya Taniguchi, Takasaki-shi (JP); Youichi Mizuno, Takasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/857,612

(22) Filed: Sep. 19, 2007

(30) Foreign Application Priority Data
Sep. 20, 2006 (JP) 2006-284356

(51) Int. Cl. H01G 4/06; H01G 7/00

(52) U.S. Cl. 361/321.4; 29/25.42

(57) ABSTRACT

A multi-layer ceramic capacitor has substantially hexagonal shape multi-layer ceramics, internal electrodes formed so as to oppose to each other by way of the dielectric ceramics and led to different end faces alternately in the multi-layer ceramic body, and end termination electrodes formed on both end faces of the multi-layer ceramics and electrically connected to the internal electrodes respectively led out to the end faces, in which the ratio between the average value D for the diameter of the grains and the average value d for the particle diameter of the raw material powder of the perovskite dielectric substance is: 1.2≦D/d≦1.5, and the average value D for the diameter of the grains constituting the dielectric ceramics is from 40 to 150 nm.

### BACKGROUND OF THE INVENTION

1. Field of the Invention

The present invention provides a method of providing a multi-layer ceramic capacitor of high reliability having a high insulating property even under a high electric field and a good life time property, and a manufacturing method thereof.

2. Description of the Related Art

A multi-layer ceramic capacitor has multi-layer ceramics constituted with dielectric ceramics formed of a perovskite raw material powder represented by ABO₃ (in which A represents one or more member selected from Ba, Ca, and Sr, and B represents one or member selected from Ti and Zr) and an additive, internal electrodes formed in the multi-layer ceramics so as to oppose to each other by way of the dielectric ceramics and led out to different end faces alternately, and end termination electrodes formed on both end faces of the multi-layer ceramics and electrically connected to the internal electrodes respectively.

As the dielectric material ceramics used for the multi-layer ceramic capacitor described above, it is preferred that reliability under a high electric field is high and dielectric constant is flat. For obtaining such dielectric ceramics, a core-shell structure was formed by suppressing the grain growth and completing firing before the additive is solid solubilized completely in the raw material powder.

As a method of forming dielectric ceramics having the core shell structure, Japanese Unexamined Patent Publication 2004-345927 discloses a method of obtaining a non-reducing dielectric ceramics by providing a raw material powder as a main ingredient represented by ABO₃ with an average grain size from 0.1 to 0.3 μm, firing a plastic body of a powder mixture obtained by mixing the raw material powder of the main ingredient and a powder of an extraneous material powder in an reducing atmosphere, wherein the obtained sintered grains have core shell particles, satisfy the condition of: core diameter<0.4×grain diameter, and the average value for the diameter of the grains is from 0.15 to 0.8 μm. Since the reliability of grain boundary can be improved by conducting sintering sufficient to attain grain growth, a non-reducing dielectric ceramics having good reliability can be obtained.

In the existent method described above, the reliability as the multi-layer ceramic capacitor is improved by sintering while conducting grain growth of the raw material powder as the main ingredient. However, in recent years, electronic instruments have been decreased in the size and smaller size and larger capacitance have been demanded for multi-layer ceramic capacitors mounted thereon. Accordingly, a further lamellation has been demanded for the dielectric material ceramic layer. Since the particle number per one layer is decreased along with lamellation of the dielectric ceramics, the number of grain boundaries forming the barrier for the movement of oxygen defects is decreased to lower the life time property. Accordingly, this resulted in a problem of lowering the reliability of the multi-layer ceramic capacitor.

In this case, for increasing the grain boundary number, while it may be considered to decrease the average value for the grain diameter. However, for decreasing the average value for the diameter of the particles to 0.15 μm or less, it is necessary to use a finer material powder (that is of 0.1 μm or less). However, since such raw material powder is highly reactive and grain growth tends to proceed, this resulted in a problem that the grains were grown to those having an average value for the diameter of 0.15 μm or more in the existent manufacturing process for the dielectric ceramics.

Further, while the lamellation proceeds also for the internal electrodes along with lamellation of the dielectric ceramics, as the lamellation proceeds in the internal electrodes, thickness of the internal electrode varies due to the unevenness caused to the boundary between the dielectric ceramics and the internal electrodes. In a case of the dielectric ceramic layer having grains undergoing grain growth, since unevenness at the boundaries with the internal electrodes increases, the thickness of the internal electrodes varies more. Accordingly, this resulted in a problem of increasing the number of portions where the strength of the electric field increases locally to lower the life time property.

### SUMMARY OF THE INVENTION

In an embodiment, the present invention is intended to overcome at least one of the foregoing problems and provide a multi-layer ceramic capacitor of a high reliability having a high insulating property and a good life time property even when the lamellation proceeds for the dielectric ceramics, and a method of manufacturing such a multi-layer ceramic capacitor.

The present invention provides, in a first embodiment, a multi-layer ceramic capacitor having substantially hexahedron multi-layer ceramics, internal electrodes formed so as to oppose to each other by way of the dielectric ceramics and so as to be led out to different end faces alternately in the multi-layer ceramics, and end termination electrodes formed on both end faces of the multi-layer ceramics and electrically connected to the internal electrodes led out to the end faces respectively, in which

the dielectric ceramics are constituted with grains formed of a perovskite dielectric substance as a raw material, and the grain growth is controlled in a range of: 1.2≦D/d≦1.5 wherein D represents the average value for the diameter of the grain and d represents the average value of the grain diameter of the raw material powder of the perovskite dielectric substance as the raw material for the dielectric ceramics such that the average value for the diameter of the grain is within a from 40 to 150 nm.

According to the first embodiment of the invention, since the grain number per one layer can be increased than usual, the boundary number can be ensured sufficiently to improve the life time property. Further, since the grain growth can be suppressed to decrease the unevenness formed on the boundaries between the dielectric ceramics and the internal electrodes, variation in the thickness of the internal electrodes can be decreased even when the internal electrodes are lamellated, thereby decreasing the portion where the strength of the electric field increases locally. Accordingly, the reliability of the multi-layer ceramic capacitor can be improved.

Further, in a second embodiment of the invention, there is provided a multi-layer ceramic capacitor wherein the average value for the particle diameter of the raw material powder of the perovskite dielectric substance as the raw material for the dielectric material ceramics is from 30 to 100 nm. According to the second embodiment of the invention, since the sintering reactivity of the raw material powder is increased, grain boundaries having high resistance can be formed even with less grain growth to improve the insulating property.

Further, the invention provides, in a further embodiment, a method of manufacturing a multi-layer ceramic capacitor having dielectric ceramics formed of a raw material powder of a perovskite dielectric substance and an additive as an extraneous material, which includes using a raw material powder with an average value for the grain diameter of from 30 to 100 nm as the raw material powder of the perovskite dielectric substance and forming dielectric ceramics having grains undergoing grain growth to 1.2 to 1.5 times the average value for the grain diameter of the raw material powder. According to this manufacturing method, it is possible to obtain a multi-layer ceramic capacitor of a high reliability having a high insulating property and a good life time property even when the dielectric ceramics are lamellated.

According to embodiments of the invention, a multi-layer ceramic capacitor of a high reliability having a high insulating property even under a high electric field and a good life time property can be obtained.

In the present invention, the endpoints of the ranges recited can be included in embodiments and excluded in other embodiments.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

FIG. 1 is a schematic cross sectional view of a multi-layer ceramic capacitor applicable in an embodiment of the present invention (in an embodiment, the number of layers may be 100 to 1,000). The drawing is oversimplified for illustrative purposes and is not to scale.

### PREFERRED EMBODIMENT OF THE INVENTION

The present invention will be explained in detail with reference to preferred embodiments. However, the preferred embodiments are not intended to limit the present invention.

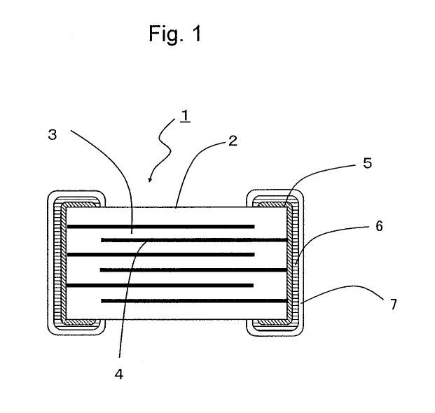

A preferred embodiment of a multi-layer ceramic capacitor according to the invention is to be described. A multi-layer ceramic capacitor 1 of this embodiment has, as shown in FIG. 1, multi-layer ceramics 2 comprising a dielectric ceramic layer 3 and internal electrodes 4 formed so as to oppose to each other by way of the dielectric ceramic layer 3 and so as to be led out to different end faces alternately. End termination electrodes 5 are formed on both end faces of the multi-layer ceramics 2 so as to be connected electrically with the internal electrodes and a first plating layer 6 and a second plating layer 7 are optionally formed thereon.

The dielectric ceramics 3 have grains comprising, as a main ingredient, a perovskite dielectric substance represented by ABO₃ (in which A represents one or more member selected from Ba, Ca, and Sr and B represents one or more member selected from Ti and Zr) and the grain growth is controlled such that the average value for the diameter of the grains is within a range from 40 to 150 nm.

Within the range for the average value of the diameter of the grains described above, where the thickness of the dielectric substance ceramics 3 is, for example, 0.9 μm (in other embodiments, 0.7 μm-10 μm including 1.0 μm, 5.0 μm, 8.0 μm, and values between any two numbers of the foregoing), when grains are arranged by the number of nine in the direction of the thickness, and grain boundaries are present at 8 positions. In an existent case where the grain is larger than 0.15 μm, that is, 150 nm, the positions for the grain boundaries are less than eight. Accordingly, since the effect of the barrier for the movement of oxygen defects due to the grain boundary is increased in the multi-layer ceramic capacitor of an embodiment of the invention, the life time property can be improved.

Further, the dielectric ceramics 3 contain rare earth compounds (La, Ce, Pr, Nd, Pm, Sm, Eu, Gd, Tb, Dy, Ho, and Y), Si compounds, compound of alkaline earth metals (Mg, Ca, and Sr) or compounds of transition metals (Mn, Cr, V, Zn, Fe, Co, etc.) as the extraneous material, and the grain has a structure in which the perovskite dielectric substance and the extraneous material are uniformly solid solubilized, or a core shell structure having a perovskite dielectric substance as a core and a shell containing extraneous material therearound.

Since it is important for the grains to suppress grain growth, it is preferred to restrict within a range: 1.2≦D/d≦1.5 that is, to restrict the grain growth within a range from 1.2 to 1.5 times in which D represents the average value for the diameter of grains and d represents an average value for the particle diameter of the raw material powder for the perovskite dielectric substance as a raw material of the dielectric ceramic layer.

The grain growth can be defined within the range of an embodiment of the invention by controlling the firing temperature, as well as controlling the composition for the dielectric ceramics 3. For example, the grain growth can be suppressed within a range of from 1.2 to 1.5 times by using a ceramic material formed by mixing the rare earth compounds by from 1 to 3 mol being indicated as oxide conversion, the alkaline earth metal compounds by from 1 to 2 mol being indicated as oxide conversion, and the transition metal compound by from 0.3 to 1.0 mol being indicated converted as oxide conversion based on 100 mol of the raw material powder for the perovskite dielectric substance such as BaTiO₃.

Further, for the raw material powder for the perovskite dielectric substance as the raw material, it is preferred to use those having the average value for the particle diameter within a range from 30 to 100 nm. By using the raw material powder as described above, the average value for the diameter of the grains can be easily defined within a range from 40 to 150 nm by suppressing the grain growth within a range from 1.2 to 1.5 times. Further, since the raw material powder with the average value for the particle diameter is from 30 to 100 nm has high surface activity and high sinterability, grain boundaries with high resistance can be obtained with less grain growth.

The internal electrodes 4 comprise a base metal such as Ni. The base metal includes, Ni, Cu or alloys thereof. The internal electrodes 4 are formed by printing a conductive paste to a ceramic green sheet by a method, for example, of screen printing. The conductive paste contains a metal material, as well as a ceramic material substantially identical with the ceramic material constituting the dielectric ceramics 3 in order to mitigate the differential shrinkage relative to the firing shrinkage of the dielectric ceramics 3.

The end termination electrodes 5 comprise Cu, Ni, Ag, a Cu—Ni alloy, or a Cu—Ag alloy and are formed by coating and baking a conductive paste to the multi-layer ceramics 2 after firing, or coating a conductive paste on a not-fired multi-layer ceramics 2 and baked simultaneously with firing of the dielectric ceramics 3. Plating layers 6, 7 are formed on the end termination electrodes 5 by electrolytic plating or the like. The first plating layer 6 has a function of protecting the end termination electrodes 5 and comprises Ni, Cu, etc. The second plating layer 7 has a function of improving solder wettability and comprises Sn or an Sn alloy.

Then, the effect of an embodiment of the invention is to be described with reference the following specific experimental examples. In this case, BaTiO₃ was used as the raw material powder for the perovskite dielectric substance. For the additive as the extraneous material, Ho₂O₃ was used as the rare earth compound, MgO was used as the alkaline earth metal compound, Mn₂O₃ was used as the transition metal compound, and SiO₂ was used as the Si compound. The starting materials described above were provided so as to form the composition shown in Table 1. In Table 1, the addition amounts of Ho₂O₃, MgO, Mn₂O₃, and SiO₂ were represented by the mol number based on 100 mol of BaTiO₃. Further, for the addition amount of the extraneous material, since the grains tend to grow further as the average value for the particle diameter of the raw material powder for the perovskite dielectric substance decreases, the addition amount was increased more as the average value of the particle diameter of the raw material powder for the perovskite dielectric material was smaller in order to suppress the grain growth.

In the present disclosure where conditions and/or structures are not specified, the skilled artisan in the art can readily provide such conditions and/or structures, in view of the present disclosure, as a matter of routine experimentation.

In the present examples, the numerical numbers applied in embodiments can be modified by a range of at least +50% in other embodiments, and the ranges applied in embodiments may include or exclude the endpoints.

TABLE 1

| Specimen | Main ingredient | Ho₂O₃ | MgO | Mn₂O₃ | SiO₂ | Firing temperature | Average grain |
|---|---|---|---|---|---|---|---|
| No. | powder diameter (nm) | (mol part) | (mol part) | (mol part) | (mol part) | (° C.) | diameter |
| 1 | 25 | 2.0 | 2.0 | 1.0 | 1.0 | 1100 | 30 |
| 2 | 25 | 2.0 | 2.0 | 1.0 | 1.0 | 1110 | 45 |
| 3 | 28 | 2.0 | 2.0 | 1.0 | 1.0 | 1120 | 40 |
| 4 | 30 | 2.0 | 2.0 | 1.0 | 1.0 | 1150 | 36 |
| 5 | 30 | 2.0 | 2.0 | 1.0 | 1.0 | 1160 | 42 |
| 6 | 30 | 2.0 | 2.0 | 1.0 | 1.0 | 1170 | 45 |
| 7 | 35 | 1.5 | 2.0 | 1.0 | 1.0 | 1170 | 41 |
| 8 | 35 | 1.5 | 2.0 | 1.0 | 1.0 | 1175 | 49 |
| 9 | 35 | 1.5 | 2.0 | 1.0 | 1.0 | 1180 | 62 |
| 10 | 50 | 1.0 | 1.5 | 0.8 | 1.0 | 1200 | 55 |
| 11 | 50 | 1.0 | 1.5 | 0.8 | 1.0 | 1210 | 60 |
| 12 | 50 | 1.0 | 1.5 | 0.8 | 1.0 | 1220 | 70 |
| 13 | 80 | 0.8 | 1.2 | 0.5 | 1.0 | 1210 | 93 |
| 14 | 80 | 0.8 | 1.2 | 0.5 | 1.0 | 1220 | 115 |
| 15 | 80 | 0.8 | 1.2 | 0.5 | 1.0 | 1230 | 123 |
| 16 | 100 | 0.5 | 1.0 | 0.5 | 1.0 | 1220 | 112 |
| 17 | 100 | 0.5 | 1.0 | 0.5 | 1.0 | 1230 | 122 |
| 18 | 100 | 0.5 | 1.0 | 0.5 | 1.0 | 1240 | 150 |
| 19 | 100 | 0.5 | 1.0 | 0.5 | 1.0 | 1250 | 155 |
| 20 | 110 | 0.5 | 1.0 | 0.5 | 1.0 | 1220 | 135 |
| 21 | 110 | 0.5 | 1.0 | 0.5 | 1.0 | 1230 | 150 |
| 22 | 150 | 0.5 | 1.0 | 0.3 | 1.0 | 1250 | 180 |

Provided raw material was mixed with water and wet-pulverized in a ball mill for 15 hours to obtain a mixture. The mixture was dried and, calcined in an atmospheric air at 800° C. for one hour to obtain a calcining body. Polyvinyl butyral as an organic binder and ethanol as a solvent were added to the calcining body and mixed to obtain a ceramic slurry. The ceramic slurry was molded into a sheet by a doctor blade to obtain a ceramic green sheet of 1.0 μm thickness.

A conductive paste was coated on the ceramic green sheet by a screen printing method to form an internal electrode pattern. Ten ceramic green sheets each formed with the internal electrode pattern were layered and hot press bonded to obtain a layered body. The layered body was cut and divided into a size of 4.0 mm×2.0 mm to obtain not fired chips. The not-fired chips were removed with the binder in a nitrogen atmosphere and then fired in a nitrogen-hydrogen gas mixture containing 1% hydrogen at a firing temperature shown in Table 1 to obtain sintered chips.

A conduction paste was coated on the internal electrode exposure surface of the obtained sintered chips and baked in a nitrogen atmosphere at 700° C. to form an end termination electrode. As described above, a multi-layer ceramic capacitor sized 3.2 mm×1.6 mm with the thickness of the dielectric ceramics between the inter electrodes of 0.75 μm was obtained.

For the obtained multi-layered ceramic capacitor, a dielectric breakdown voltage (BDV), an insulation resistance value (IR), an average life time, and permittivity were measured. The specimens were used each by the number of 10, the applied voltage was increased at a rate of 10 V/sec in an atmosphere at 25° C. and a voltage value causing short circuit was measured and the average value thereof was defined as the dielectric breakdown voltage.

Further, the specimens were used each by the number of 10, a DC voltage at 100 V was applied at 25° C. and the resistance after one min was measured and the average value thereof was defined as the insulation resistance value. Further, the specimens were used each by the number of 30, a high temperature accelerated life time test was conducted under the condition at 150° C. and at a DC voltage 50 kV/mm, and the average value for the time at which the insulation resistance value lowered to 10⁵Ω or less was defined as the average life time. The specimens were used each by the number of five and an electrostatic capacitance was measured at an AC voltage of 0.5 V and at 1 kHz, at a temperature of 200° C., and the average value for the values calculated based on the intersection area of internal electrodes, the number of layers and the thickness of dielectric material was defined as the permittivity.

Further, the raw material powder was observed by SEM (Scanning Electron Microscope) under magnification by 50,000×, and the diameter was measured for the particles by the number of 300 and the average value thereof was defined as the average value for the particle diameter of the raw material powder. Further, the lateral cross section of the multi-ceramic capacitor was exposed by polishing and observed by SEM under magnification by 50,000×, the diameters for the grains by the number of 300 were measured for dielectric ceramics between the internal electrodes and the average value thereof was defined as the average value for the diameter of the grains. Further, D/d was calculated by using the average value for each of them. Table 2 shows the result of the measurements described above.

TABLE 2

| | Average raw | | Average grain | Dielectric | | | | |
|---|---|---|---|---|---|---|---|---|
| | material | Average | diameter/average | breakdown | Insulation | Average | | |
| Specimen | powder | grain | raw material | voltage: DV | resistance | life time | | Reliability |
| No. | diameter | diameter | powder diameter | (V/μm) | value: IR (Ω) | (sec) | Permittivity | evaluation |
| *1 | 25 | 30 | 1.20 | 85 | 5.20E+10 | 4539 | 292 | X |
| *2 | 25 | 45 | 1.80 | 87 | 2.32E+11 | 5324 | 734 | X |
| 3 | 28 | 40 | 1.43 | 79 | 7.20E+10 | 7991 | 628 | Δ |
| *4 | 30 | 36 | 1.20 | 89 | 1.30E+10 | 7899 | 412 | X |
| 5 | 30 | 42 | 1.40 | 130 | 8.29E+10 | 10829 | 511 | ◯ |
| 6 | 30 | 45 | 1.50 | 112 | 1.23E+11 | 11837 | 783 | ◯ |
| *7 | 35 | 41 | 1.17 | 142 | 2.30E+10 | 11530 | 677 | X |
| 8 | 35 | 49 | 1.40 | 110 | 1.18E+11 | 13478 | 972 | ◯ |
| *9 | 35 | 62 | 1.77 | 67 | 2.52E+11 | 6429 | 1230 | X |
| *10 | 50 | 55 | 1.10 | 150 | 1.90E+10 | 9249 | 1100 | X |
| 11 | 50 | 60 | 1.20 | 124 | 6.70E+10 | 14298 | 1230 | ◯ |
| 12 | 50 | 70 | 1.40 | 149 | 1.98E+11 | 15266 | 1321 | ◯ |
| *13 | 80 | 93 | 1.16 | 128 | 3.32E+10 | 23109 | 1692 | X |
| 14 | 80 | 115 | 1.44 | 115 | 2.09E+11 | 12209 | 2040 | ◯ |
| *15 | 80 | 123 | 1.54 | 104 | 3.30E+11 | 7367 | 2254 | X |
| *16 | 100 | 112 | 1.12 | 156 | 1.83E+10 | 9245 | 2021 | X |
| 17 | 100 | 122 | 1.22 | 140 | 6.70E+10 | 13176 | 2090 | ◯ |
| 18 | 100 | 150 | 1.50 | 120 | 1.92E+11 | 11202 | 2592 | ◯ |
| *19 | 100 | 155 | 1.55 | 65 | 2.04E+11 | 4589 | 2689 | X |
| 20 | 110 | 135 | 1.23 | 92 | 5.43E+10 | 12298 | 2249 | Δ |
| 21 | 110 | 150 | 1.36 | 82 | 9.00E+10 | 11938 | 2432 | Δ |
| *22 | 150 | 180 | 1.20 | 50 | 5.60E+10 | 2293 | 3192 | X |

Out of the scope of an embodiment of the invention

It was evaluated as satisfactory in a case where the dielectric breakdown voltage was 75 V/μm or higher, the insulation resistance value was 5.0×10¹⁰Ω or higher, the average life time was 7500 sec or more and the permittivity was 500 or more. As a result, satisfactory properties were obtained for No. 3, Nos. 5 and 6, No. 8, Nos. 11 and 12, No. 14, Nos. 17 and 18, and Nos. 20 and 21 in which the average value for the diameter of the grains was within a range from 40 nm to 150 nm and D/d was within a range form 1.2 to 1.5.

For No. 2, No. 7, No. 9, No. 10, No. 13, No. 15 and No. 16, while the average value for the diameter of the grains was within a range from 40 nm to 150 nm, D/d was out of the range of 1.2 to 1.5. Among them, for No. 7, No. 10, No. 13 and No. 16, D/d was less than 1.2 and the insulation resistance value was 5.0×10¹⁰Ω or lower. This is because sintering was not sufficient since the extent of the grain growth was small and the resistance value of the grain boundary tends to decrease. Further, for No. 2, No. 9, and No. 15, D/d shows a value larger than 1.5 and the average life time was 7500 sec or less. This is because the coarse grains tended to increase since the extent of the grain growth was large and, therefore, the number of portions where the strength of the electric field increase locally is increased. Accordingly, in a case where the average value for the diameter of the grains was from 40 to 150 nm and the value for D/d was 1.2 or more and 1.5 or less, the dielectric breakdown voltage is 75 V/μm or higher, the insulation resistance value is 5.0×10¹⁰Ω or higher and the average life time is 7500 sec or more and more preferred characteristics are obtained for the multi-layered ceramic capacitor.

Further, among the specimens in which the average value for the diameter of the grains is from 40 to 150 nm and the value for D/d is within a range from 1.2 to 1.5, No. 3 in which the average value for the grain diameter of the raw material powder is less than 30 nm, the average life time is 7500 sec or more but less than 10,000 sec and the dielectric break voltage value is 75 V/μm or more but lower than 100 V/μm. This is because the additive tends to be less dispersed in a case where the average value for the particle diameter of the raw material powder is small tending to cause variation in the solid solution of the additive or the formation of the core shell structure. Further, also for Nos. 20, 21 in which the average value for the grain diameter of the starting powder, the dielectric breakdown voltage value was 75 V/μm or higher but lower than 100 V/μm. This is because the sintering reactivity is lowered along with increase in the average value for the grain diameter of the raw material powder and the insulation resistance of the grain boundary tends to lower relatively, and dielectric break tends to be caused at a relatively low electric field strength.

For other specimens, since the average value for the diameter of the grains is from 40 to 150 nm, the value for D/d is within a range from 1.2 to 1.5, and the average value for the grain diameter of the main material powder is 30 nm or more and 100 nm or less, the dielectric breakdown voltage is 100 V/μm or higher, the insulation substance value is 5.0×10¹⁰Ω or higher, and the average life time is 10,000 sec or more, to obtain more properties.

As described above, a multi-layer ceramic capacitor having the average grain size, D/d, and the average value for the particle diameter of the raw material powder are within the range of an embodiment of the invention can provide a multi-layer ceramic capacitor of high reliability.

The present application claims priority to Japanese Patent Application No. 2006-284356, filed Sep. 20, 2006, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A multi-layer ceramic capacitor having substantially hexahedron multi-layer ceramics, internal electrodes formed so as to oppose to each other by way of the dielectric ceramics and so as to be led out to different end faces alternately in the multi-layer ceramics, and end termination electrodes formed on both end faces of the multi-layer ceramics and electrically connected to the internal electrodes led out to the end faces respectively, in which
the dielectric ceramics are constituted with grains formed of a perovskite dielectric substance as a raw material, and
the grain growth is controlled in a range of: 1.2≦D/d≦1.5 wherein D represents the average value for the diameter of the grain, and d represents the average value of the grain diameter of the raw material powder of the perovskite dielectric substance as the raw material for the dielectric ceramics such that the average value for the diameter of the grain is within a from 40 to 150 nm.

2. A multi-layer ceramic capacitor according to claim 1, wherein
the average value for the particle diameter of the raw material powder of the perovskite dielectric substance as the raw material for the dielectric material ceramics is from 30 to 100 nm.

3. A multi-layer ceramic capacitor according to claim 1, wherein
the dielectric ceramics are formed of a perovskite dielectric substance and an extraneous material.

4. A multi-layer ceramic capacitor according to claim 3, wherein
the extraneous material contains compounds of rare earth (La, Ce, Pr, Nd, Pm, sm, Eu, Gd, Tb, Dy, Ho, and Y), Si compounds, alkaline earth metal compounds, or transition metal compounds.

5. A method of manufacturing a multi-layer ceramic capacitor having dielectric ceramics formed of a raw material powder for a perovskite dielectric substance and an additive as an extraneous material, which includes
using a raw material powder with an average value for the grain diameter of from 30 to 100 nm as the raw material powder for the perovskite dielectric substance and forming dielectric ceramics having grains which a grain growth to 1.2 to 1.5 times the average value for the grain diameter of the raw material powder.

6. A method of manufacturing a multi-layer ceramic capacitor comprising substantially or nearly hexahedron multi-layer ceramics composed of a plurality of dielectric ceramic layers stacked in a thickness direction, and a plurality of internal electrode layers each formed between adjacent two dielectric ceramic layers stacked next to each other, said method comprising:
providing a perovskite dielectric substance as a raw material composed of raw grains having an average diameter of 30 nm to 100 nm;
providing an extraneous material;
mixing the grains and the extraneous material;
sintering the mixture; and
controlling grain growth in a range of: 1.2≦D/d≦1.5 wherein D represents an average diameter of sintered grains constituting the ceramic layers which is 40 to 150 nm, and d represents an average diameter of raw grains.

7. The method according to claim 6, wherein the step of providing the extraneous material comprises selecting one or more compounds from the group consisting of rare earth compounds, Si compounds, alkaline earth metal compounds, and transition metal compounds.

8. The method according to claim 7, wherein the step of mixing comprises adding 1-3 mol of rare earth compound(s), 1-2 mol of Si compound(s), and 0.3-1 mol of alkaline earth metal compound(s), per 100 mol of the perovskite dielectric substance.

9. The method according to claim 6, wherein the step of controlling the grain growth comprises controlling the grain growth as a function of the average diameter of the raw grains and the sintering temperature

10. A multi-layer ceramic capacitor comprising:
substantially or nearly hexahedron multi-layer ceramics comprised of a plurality of dielectric ceramic layers stacked in a thickness direction and having two end surfaces opposite to each other formed by ends of the plurality of dielectric ceramic layers;
internal electrodes each formed between the respective dielectric ceramic layers stacked next to each other, said internal electrodes extending alternately from the respective two end surfaces; and
end termination electrodes formed on both of the two end surfaces and electrically connected to each of the internal electrodes extending therefrom, wherein
each dielectric ceramic layer is a sintered body of a perovskite dielectric substance material and an extraneous material, said sintered body being composed of sintered grains having an average diameter of 40 to 150 nm, and
said multi-layered ceramic capacitor having an average life time as measured by a high temperature accelerated life time test, which is at least 10% longer than an average life time of a multi-layered ceramic capacitor having an equivalent configuration manufactured by controlling grain growth in a range of D/d≦1.2 or D/d>1.5 wherein D represents an average diameter of sintered grains constituting the ceramic layers, and d represents an average diameter of raw grains.

11. The multi-layer ceramic capacitor according to claim 10, wherein the extraneous material comprises one or more compounds selected from the group consisting of rare earth compounds, Si compounds, alkaline earth metal compounds, and transition metal compounds.

12. The multi-layer ceramic capacitor according to claim 11, wherein the extraneous material comprises 1-3 mol of rare earth compound(s), 1-2 mol of Si compound(s), and 0.3-1 mol of alkaline earth metal compound(s), per 100 mol of the perovskite dielectric substance.

13. The multi-layer ceramic capacitor according to claim 10, wherein each dielectric ceramic layer has a thickness of 0.8 μm to 10 μm.
